(19) United States
(12) Patent Application Publication
(10) Pub. No.: US 2014/0174667 A1
(43) Pub. Date: Jun. 26, 2014

(54) BARRIER MATERIAL ROLLER APPLICATOR

(71) Applicants: Kevin M. Eliason, River Falls, WI (US); Aaron T. Nunberg, St. Paul, MN (US)

(72) Inventors: Kevin M. Eliason, River Falls, WI (US); Aaron T. Nunberg, St. Paul, MN (US)

(73) Assignee: 3M INNOVATIVE PROPERTIES COMPANY, St. Paul, MN (US)

(21) Appl. No.: 14/239,572

(22) PCT Filed: Aug. 22, 2012
(86) PCT No.: PCT/US2012/051812

§ 371 Date: Feb. 19, 2014

Related U.S. Application Data
(60) Provisional application No. 61/526,354, filed on Aug. 23, 2011.

(51) Int. Cl. B44C 7/06

(52) U.S. Cl. CPC B44C 7/06
USPC 156/577

(57) ABSTRACT

A barrier material applicator is disclosed that includes a frame and a roll support member coupled to the frame, the roll support configured to rotatably support a roll of barrier material. The applicator further includes at least two rotatable applicator rollers. A first applicator roller and a second applicator roller are configured to receive a sheet of barrier material from the roll support and apply the barrier material to a substantially planar surface.

### BACKGROUND

The present disclosure relates to barrier material applicators, and, more particularly, to barrier material applicators including rollers.

Barrier or containment materials, such as films and webs, are often used to isolate a working environment from outside contamination and vice versa. Examples of barrier materials include polymeric sheeting, liners, carpets and tarps sold under the BearAcade® brand by Americover, Inc., Escondido, Calif. Other exemplary barrier materials include materials used for protecting surfaces of paint spray booths, such as 3M™ Dirt Trap Protection Films and Materials, available from 3M Company, St. Paul, Minn. This product has also been useful in improving the appearance of paint spray booths and capturing dust and dirt that can cause defects in newly painted surfaces. Various other barrier materials are also known, such as impermeable, permeable, or porous films or webs.

Known barrier materials are typically provided as sheeting in roll form. Application of the sheeting to various surfaces of the work environment has been accomplished with the aid of magnetic roll holders that may be attached to the wall at the installer's height. The sheeting was then pulled off the roll the length of a surface to be covered and applied to the surface. Such systems, available from 3M Company, are known as 3M™ Dirt Trap Protection Systems. Other devices for dispensing and applying barrier materials are available, for example from Norkan Inc. These devices use an application roller to press the material to a surface to be covered as the material is pulled off the roll it is originally provided on.

The available barrier material applicators may not enable as fast and easy an application process as desired. Thus, there remains a need in the art for improved barrier material applicators in order to make the application process faster and less labor intensive.

### SUMMARY

In one implementation, the present disclosure is directed to a barrier material applicator having a frame and a roll support member coupled to the frame, the roll support configured to rotatably support a roll of barrier material. The barrier material applicator further includes a first applicator roller and a second applicator roller. The first applicator roller is configured to rotate about a first axis in at least a first direction, and the second applicator roller is configured to rotate about a second axis in at least a second direction, the second direction being the same as the first direction. The first applicator roller and the second applicator roller are configured to receive a sheet of barrier material from the roll support and apply it to a substantially planar surface.

In another implementation, the barrier material applicator further includes an elongated operator handle coupled to the frame. In yet another implementation, the barrier material applicator further includes a base movable with respect to a generally horizontal surface. A vertical support may be coupled to the base and extend away from the base. In such exemplary embodiments, the frame may be coupled to the vertical support.

### BRIEF DESCRIPTION OF THE DRAWINGS

The invention may be more completely understood in consideration of the following detailed description of various embodiments of the invention in connection with the accompanying drawings, in which:

FIG. 1 shows an exemplary embodiment of a barrier material applicator according to the present disclosure.

FIG. 2 shows an exemplary embodiment of a barrier material applicator according to the present disclosure.

FIG. 3 shows an exemplary embodiment of a barrier material applicator according to the present disclosure.

FIG. 4 shows an exemplary embodiment of a floor barrier material applicator according to the present disclosure.

FIG. 5 shows an exemplary embodiment of a floor barrier material applicator according to the present disclosure.

FIG. 6 shows an exemplary embodiment of a floor barrier material applicator according to the present disclosure.

FIG. 7 shows an exemplary embodiment of a wall barrier material applicator according to the present disclosure.

FIG. 8 shows an exemplary locking apparatus suitable for use in exemplary embodiments of the present disclosure.

The figures are not necessarily to scale. Like numbers used in the figures refer to similar components. However, it will be understood that the use of a number to refer to a component in a given figure is not intended to limit the component in another figure labeled with the same number.

### DETAILED DESCRIPTION

All scientific and technical terms used herein have meanings commonly used in the art unless otherwise specified. Unless otherwise indicated, all numbers expressing feature sizes, amounts, and physical properties used in the specification and claims are to be understood as being modified in all instances by the term “about.” As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

Barrier material applicators according to the present disclosure are designed to apply a barrier material, such as the barrier materials mentioned above, including adhesive backed materials, to various surfaces, including but not limited to a horizontal floor or ceiling surface and/or a vertical wall surface. Embodiments of the present disclosure can be used to apply and roll out barrier material on a surface in one operation, thus greatly reducing formation of wrinkles as well as application time. Embodiments of the present disclosure also advantageously allow for conformability over uneven surfaces or small obstacles, such as window frames, light fixtures, bolt heads, etc. Some embodiments of the present disclosure are designed to be easily adjustable to apply multiple levels of barrier material, maintaining a desired height from the ground.

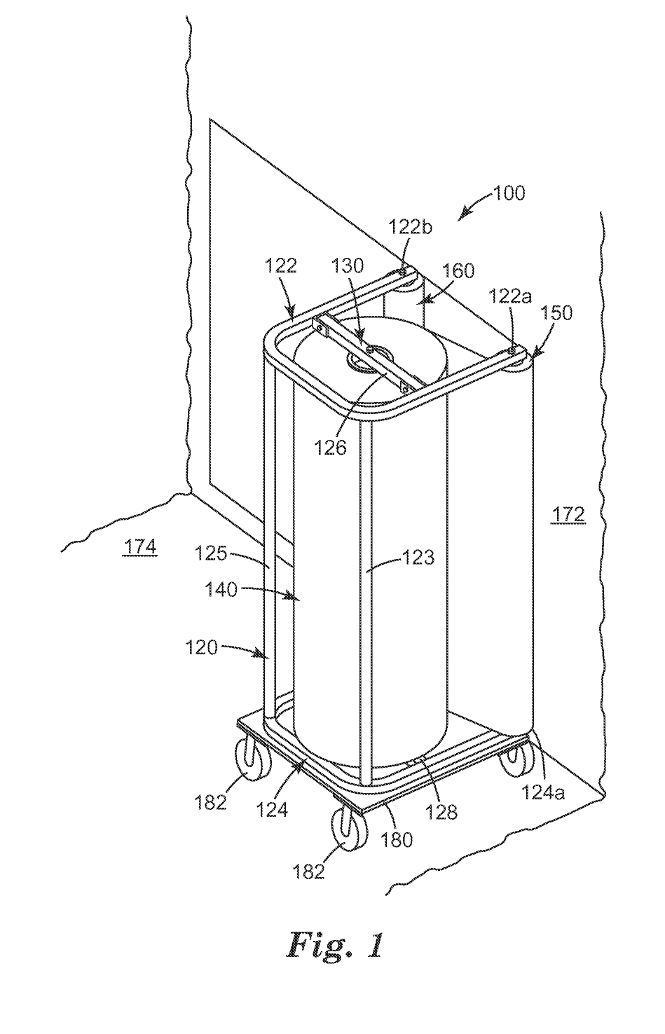

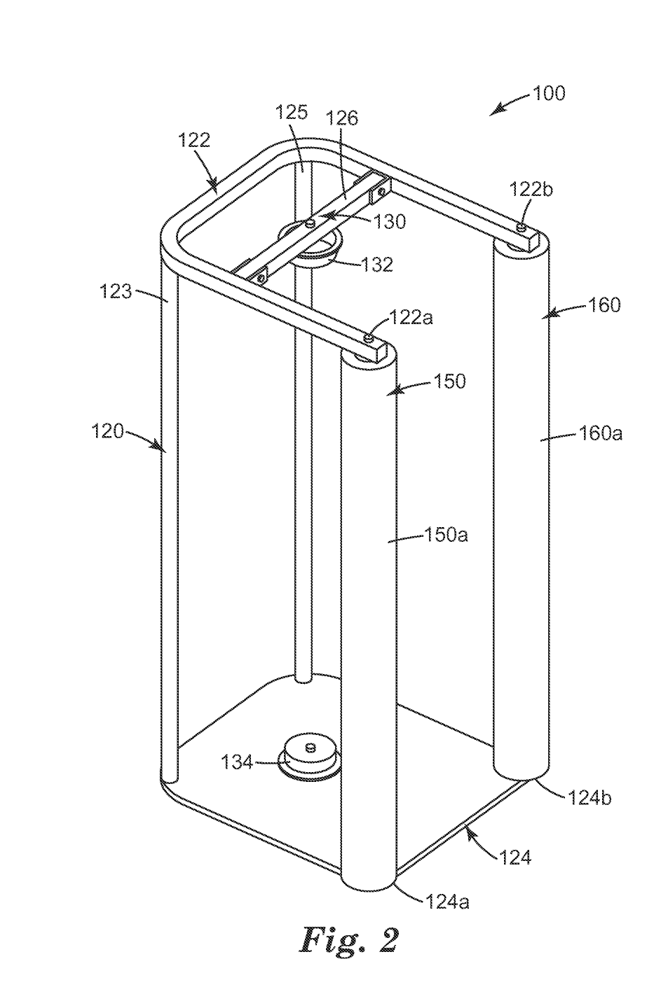

FIGS. 1-3 shows an exemplary barrier material applicator 100, designed to apply a barrier material, such as an adhesive backed material capable of trapping dirt, to a vertical wall surface. The barrier material applicator has a frame 120. A roll support member 130 is coupled to the frame 120 and is configured to rotatably support a roll of barrier material 140. The exemplary frame 120 includes a first, e.g., upper, frame portion 122 and a second, e.g., lower, frame portion 124. Although, in the embodiment illustrated in FIG. 1, the first and second frame portions each have an outer periphery shaped generally as a U-shaped bracket, other shapes are within the scope of the present disclosure, such as brackets with sharp corners, or any other shapes suitable for the application. For example, as shown in FIG. 2, the first frame portion 122 may have an outer periphery shaped generally as a U-shaped bracket, while the second frame portion 124 may include a plate which may have a generally square shape. The first and second frame portions 122, 124 are connected, for example, by one or more beams, e.g., first beam 123 and a second beam 125. Preferably, the one or more beams 123, 125 should be at least as long as or longer than a roll or the barrier material 140. One or more beams may include a handle to enable an operator to move the frame as desired, or, one or more beams may serve as a handle or handles.

In some exemplary embodiments, the roll of barrier material 140 may be coupled, on one end to the first frame portion 122 and, on another end, to the second frame portion 124. For example, as illustrated in FIG. 1, the roll of barrier material 140 may be coupled, on one end to a first cross beam 126, and, on another end, to a second cross beam 128. Alternatively, as illustrated in FIG. 2, the roll of barrier material 140 may be coupled, on one end to a first cross beam 126, and, on another end, to a plate. The roll support member 130 may include a first rotatable hub 132 coupled to the first frame portion 122, for example, at the first cross beam 126, and a second rotatable hub 134 coupled to the second frame portion 124, for example, at the second cross beam 128 or plate. The first and second rotatable hubs 132, 134 may be configured to fit inside a hollow core of the roll of barrier material 140.

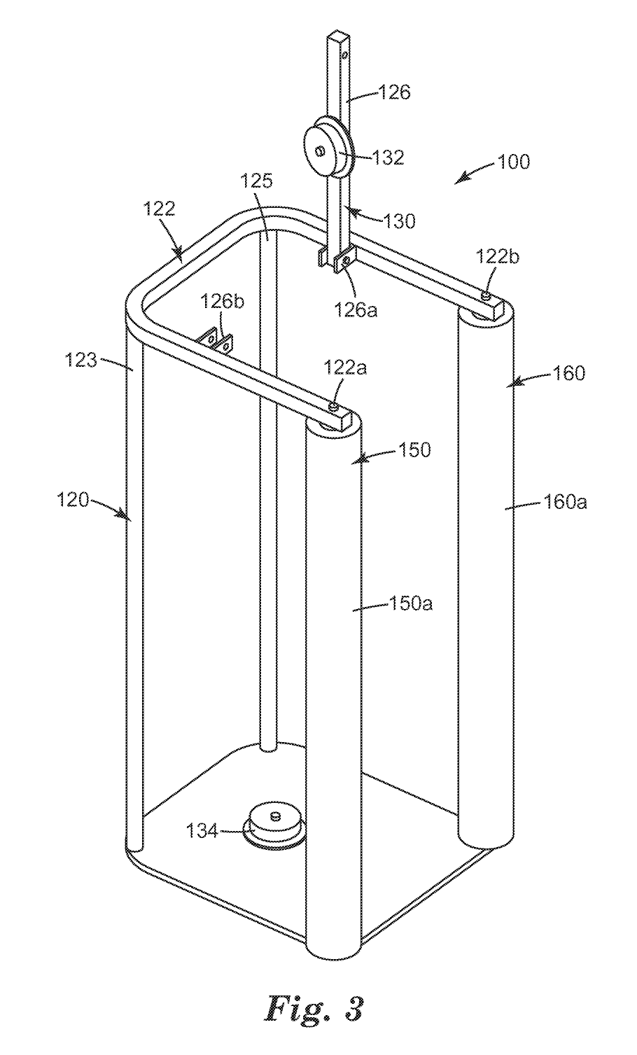

To load a roll of barrier material 140 into the frame 120, a section of the frame 120 may be displaced to allow the roll of barrier material to be inserted into the frame and rotatably positioned on the roll support member 130. For example, as illustrated in FIG. 3, the cross beam 126 of the upper frame portion 122 may be opened, e.g., by pivoting it about a hinge 126a, to allow an end of a roll of barrier material 140 to engage with the second rotatable hub 134. The cross beam 126 may then be closed so that the first rotatable hub 132 engages another end of the roll of barrier material 140. The cross beam 126 may then be removably attached, e.g., bolted, to a section 126b of the frame 122.

The applicator 100 also includes a first applicator roller 150 configured to rotate about a first axis in at least a first direction and a second applicator roller 160 configured to rotate about a second axis in at least a second direction. The first and second applicator rollers 150 and 160 are capable of rotating about their long axes in at least one direction and, more typically, in both directions (i.e., clockwise and counterclockwise). Preferably, the first applicator roller 150 is capable of rotating in the same direction as the second applicator roller 160. One or both of the applicator rollers may include conformable material, such as foam, disposed at least on an outer surface 150a, 160a of an applicator roller 150, 160. Preferably, one or both applicator rollers include a layer of conformable material, such as a foam material, that is sufficiently thick to enable the roller to conform to non-flat surfaces of small obstacles, such as bolt heads, window and door frames, lighting fixtures, etc. In some exemplary embodiments, the layer of conformable material will have a thickness of at least 0.25″. Suitable foam materials include a variety or soft yet resilient and durable polymeric foams, including EPDM, NPVC, PVC, synthetic rubber, urethane, urethane blends, PE, PP, acrylics, etc. A layer of conformable material may be disposed on a core of a more rigid material, such as rigid plastic or metal. The applicator roller core may be hollow or solid.

One end of the exemplary applicator roller 150 is coupled to a distal end 122a of the first frame portion 122, while another end of the applicator roller 150 is coupled to a distal end 124a of the lower frame portion 124. Similarly, an upper end of the exemplary applicator roller 160 may be coupled to a distal end 122b of the upper frame portion 122, while a lower end of the applicator roller 160 may be coupled to a distal end (not shown) of the lower frame portion 124. The applicator rollers 150 and 160 can be coupled to the frame, for example, by bolting, welding or otherwise attaching one or more solid or hollow axles to one or more of the distal ends of the upper and/or lower frame portions 122 and 124. Thus mounted one or more axels may extend the entire length of the frame or only a portion of the length of the frame. The application rollers would then be mounted onto the one or more axels, such that they could rotate thereon. In an exemplary embodiment, axles can be attached to each of the four proximal ends of the first and second frame portions 122 and 124. Each of these axles may extend through only a portion of the length of an application roller, and the application rollers so mounted would be capable of rotating thereon. Generally, any mounting system allowing the application rollers to spin sufficiently freely to enable barrier material application as set for in the present disclosure are within its scope.

The first applicator roller 150 and the second applicator roller 160 are configured to receive a sheet of barrier material from the roll of barrier material 140 rotatably mounted on the roll support 130 and apply it to a substantially planar surface, such as a wall 172. Preferably, an outer surface of each the first and second applicator rollers projects beyond the distal ends (e.g., 122a, 122b and 124a) of the upper and lower frame portions 124a, so that the frame does not touch the surface to which the barrier material is being applied.

The first and second applicator rollers 150 and 160 may be coupled to the frame 120 such that the axis or rotation of the first applicator roller 150 (the first axis) and the axis or rotation of the second applicator roller 160 (the second axis) define a plane. In some exemplary embodiments, the first axis is parallel to the second axis. The roll of barrier material 140 may be coupled to the frame 120 such that the axis or rotation of the roll of barrier material 140 (the third axis) is parallel to the first axis and the second axis. For example, the rotatable hubs 132 and 134 can be configured to hold the roll of barrier material 140 parallel to the applicator rollers 150 and 160 while rotating freely when barrier material is applied to a surface. These aspects of exemplary embodiments of the present disclosure may be advantageous for effective application of barrier materials in an efficient manner and for wrinkle reduction.

The barrier material applicator 100 may further include a base 180. The base 180 is designed such that it is movable with respect to a generally horizontal surface, e.g., the floor 174 on which the barrier material applicator can be disposed during use. The base 180 may be coupled to the frame 120 directly or through one or more intermediate components. Wheels 182 may be coupled to the base 180 to effectuate its movability. The number and type of wheels may depend on the application.

During use, barrier material disposed on the barrier material roll 140 can be pulled over the first applicator roller 150 and further over the second applicator roller 160. A sheet of the barrier material disposed over the first and second applicator rollers of typical embodiments forms a substantially planar configuration, such that when the barrier material applicator is moved on the floor 174 to an area of the wall 172 where the barrier material application is desired, the sheet of barrier material may be conveniently applied to the wall area without excessive wrinkling Once the barrier material is in contact with the wall 172, the base may be moved along the wall/floor interface. At the same time, the barrier material can be transferred from the barrier material roll 140 to the first applicator roller 150 and further to the second applicator roller 160. Thus, the applicator rollers according to the present disclosure are capable of presenting barrier material to a wall surface in a substantially planar form, so that fewer wrinkles are formed, as well as rolling out barrier material wrinkles if such wrinkles do form.

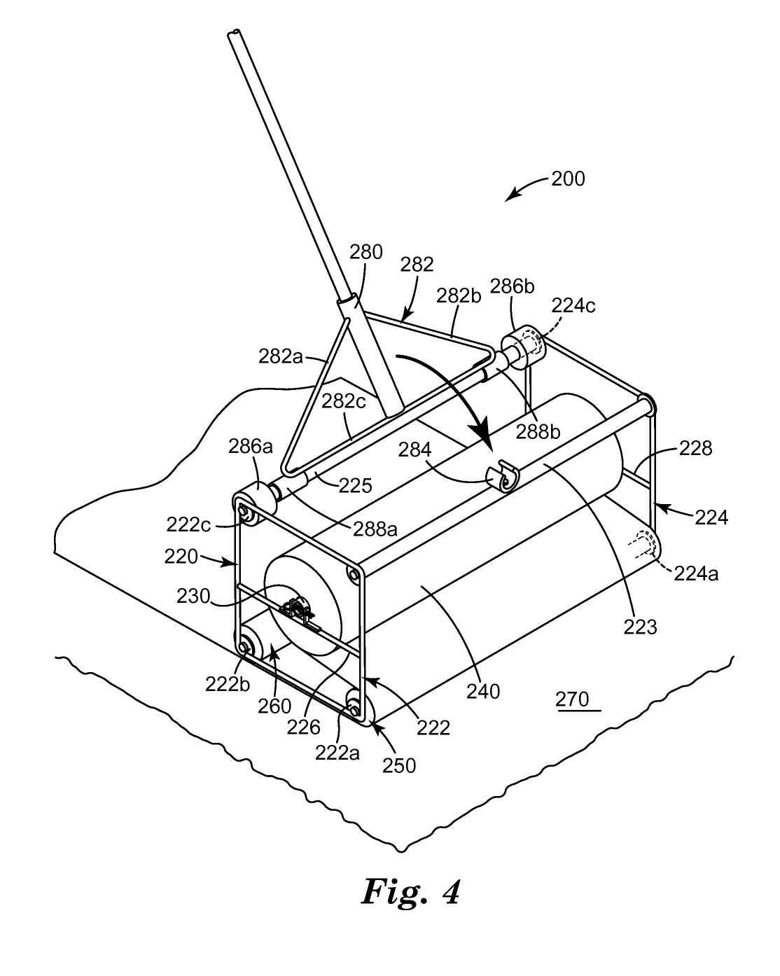

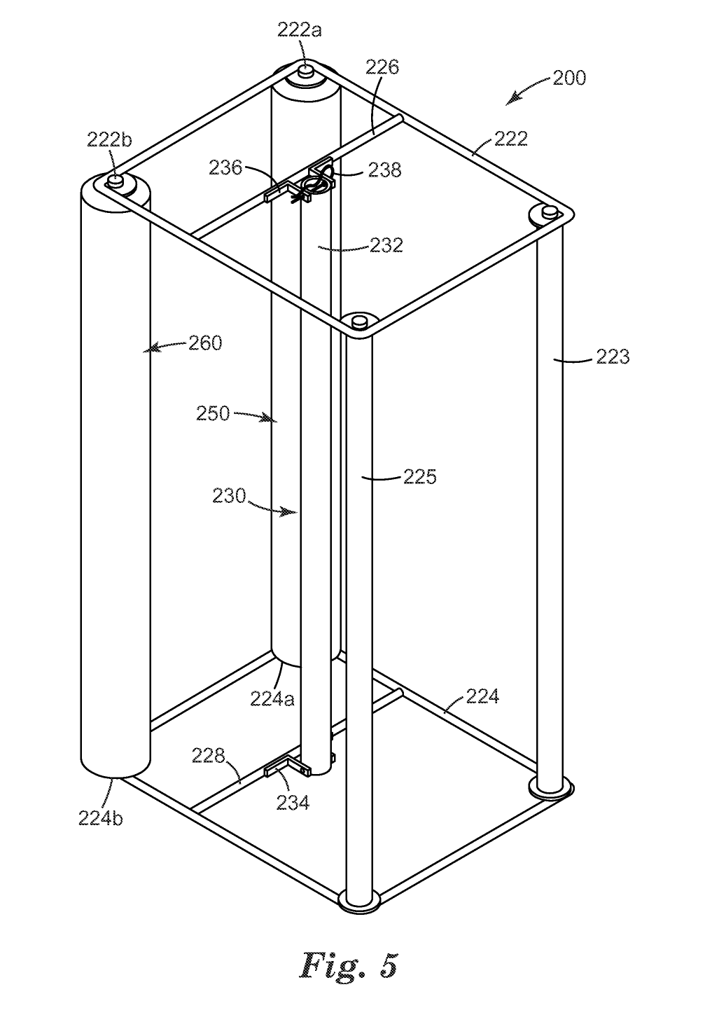

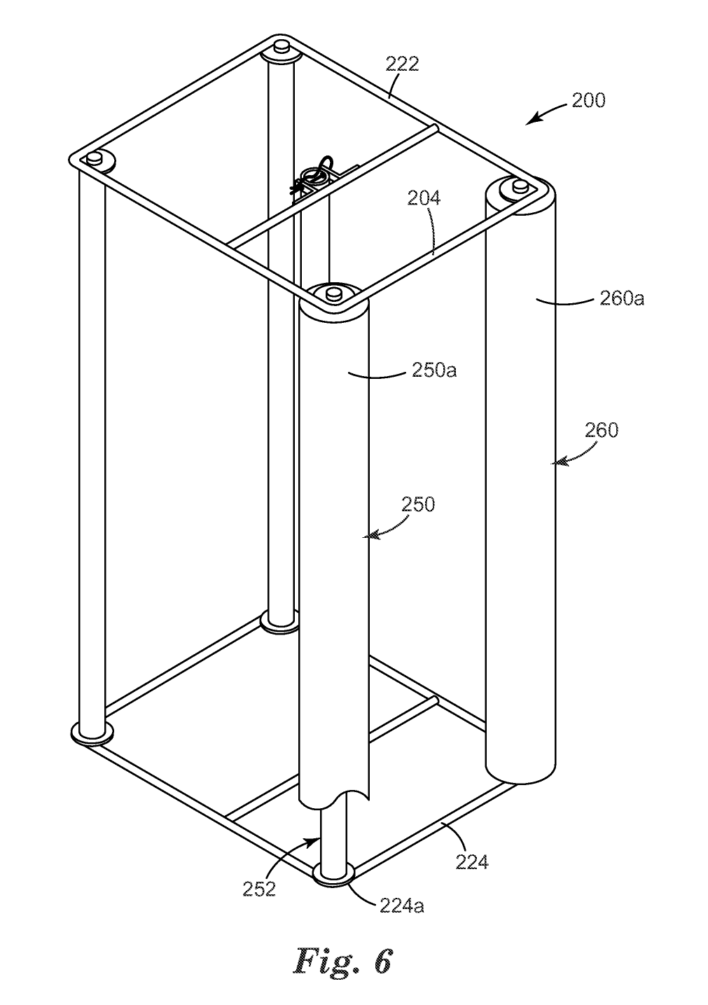

FIGS. 4-6 show an exemplary barrier material applicator 200, designed to apply a barrier material, such as an adhesive backed material capable of trapping dirt, to a horizontal floor (or ceiling) surface. The barrier material applicator has a frame 220. A roll support member 230, illustrated in more detail in FIGS. 5 and 6, is coupled to the frame 220 and is configured to rotatably support a roll of barrier material 240. The exemplary frame 220 includes a first frame portion 222 and a second frame portion 224. Although in the illustrated embodiment, the first and second frame portions each have a generally rectangularly shaped outer periphery; other shapes are within the scope of the present disclosure. The first and second frame portions 222, 224 are connected, for example, by one or more beams, such as first and second beams 223, 225. Preferably, the one or more beams 223, 225 should be at least as long as or longer than a roll of barrier material 240.

The roll of barrier material 240 may be coupled, on one end to the first frame portion 222 and, on another end, to the second frame portion 224. For example, the roll of barrier material 240 may be coupled, on one end to a first cross beam 226, and, on another end, to a second cross beam 228. The roll support member 230 may include a roll support core 232 connected on one end to the second frame portion 224, for example, at the second cross beam 228, for example, with a bracket 234. Another end of the roll support core 232 may be removably connected, e.g., using a clip 238 cooperating with a bracket 236, to the first frame portion 222, for example, at the first cross beam 226. To load a roll of barrier material 240 into the frame 220, the roll support core 232 may be disengaged from the frame 220, for example, by removing the clip 238 from the bracket 236. A roll of barrier material 240 may then be positioned on the roll support core 232, such that the roll may rotate around the core when the barrier material applicator 200 is in use. The roll support core 232 may then be re-engaged with the frame 220, for example, by inserting the clip 238 into the bracket 236.

The applicator 200 also includes a first applicator roller 250 configured to rotate about a first axis in at least a first direction; and a second applicator roller 260 configured to rotate about a second axis in at least a second direction. The first and second applicator rollers 250 and 260 are capable of rotating about their long axes in at least one direction and, more typically, in both directions (i.e., clockwise as well as counterclockwise). Preferably, the first applicator roller 250 is capable of rotating in the same direction as the second applicator roller 260. One or both the applicator rollers 250 and 260 may have any suitable construction and include any suitable materials, such as those mentioned in connection with the previously described embodiments. For example, one or both of the applicator rollers 250, 260 may include conformable material disposed on an outer surface 250a, 260a of an applicator roller.

A first end of the exemplary first applicator roller 250 is coupled to a juncture 222a of the first frame portion 222, while a second end of the applicator roller 250 is coupled to a juncture 224a of the second frame portion 224. Similarly, a first end of the exemplary second applicator roller 260 may be coupled to a juncture 222b of the first frame portion 222, while a second end of the second applicator roller 260 may be coupled to a juncture 224b of the second frame portion 224. As illustrated in FIG. 6, the applicator rollers 250 and 260 can be coupled to the frame, for example, by bolting, welding or otherwise attaching one or more solid or hollow axles (e.g., 252) to one or more junctions of the first and/or second frame portions 222 and 224 (e.g., 224a). Thus mounted, one or more axels may extend the entire length of the frame or only a portion of the length of the frame. The application rollers would then be mounted onto the one or more axels, such that they could rotate thereon. In an exemplary embodiment, axles can be attached to each of the four junctures of the first and second frame portions 222 and 224. Each of these axles may extend through only a portion of the length of an application roller, and the application rollers so mounted would be capable of rotating thereon. Generally, any mounting system allowing the application rollers to spin sufficiently freely to enable barrier material application as set for in the present disclosure are within its scope.

The first applicator roller 250 and the second applicator roller 260 are configured to receive a sheet of barrier material from the roll of barrier material 240 rotatably mounted on the roll support 230 and apply it to a substantially planar surface, here, the floor 270. Preferably, an outer surface of each of the first and second applicator rollers projects beyond the first or second frame portions (e.g., the joints 222a, 222b, 224a and 224b), so that the frame does not touch the surface to which the barrier material is being applied.

The first and second applicator rollers 250 and 260 may be coupled to the frame 220 such that the axis or rotation of the first applicator roller 250 (the first axis) and the axis or rotation of the second applicator roller 260 (the second axis) define a plane. In some exemplary embodiments, the first axis is parallel to the second axis. The roll of barrier material 240 may be coupled to the frame 220 such that the axis or rotation of the roll of barrier material 240 (the third axis) is parallel to the first axis and the second axis.

The exemplary barrier material applicator 200 further includes an elongated operator handle 280 coupled to the frame 220. The operator handle 280 typically includes an elongated rigid structure, such as a rigid plastic or metal tube or rod. The handle should be long enough that an operator holding its end that is opposite the end connected to the frame 220 would be able to stand up straight. The operator handle 280 may be coupled to the frame 220, such that when the first and second applicator rollers are disposed on a substantially horizontal surface (e.g., floor 270), the location where the operator handle 280 is joined to the frame is disposed above a plane comprising the first and second applicator rollers 250 and 260. In some embodiments, the operator handle 280 may be rotatable with respect to the frame 220. In particular, the elongated handle may be rotationally attached to the beam 225 connecting the first frame portion 222 and the second frame portion 224.

The rotational attachment may be accomplished, for example, by bolting, welding or otherwise attaching an axle 225 to a junction 222c disposed on the first frame portion 222 and to a junction 224c disposed on the second frame portion 224. In such embodiments, the operator handle 280 may be attached to a tube or sleeve that is capable of rotating with respect to the axle. In an exemplary embodiment, the operator handle 280 is attached to two or more sleeves 288a and 288b by means of an armature 282. For example, one or more struts 282a, 282b may be connected, on one end, to a sleeve 288a, 288b and, on another end, to the handle 280. The struts 282a, 282b may also be connected to each other by an elongated member 282c. The operator handle 280 may also be connected to the elongated member 282c. However, other rotational attachment mechanisms may be used to attach the operator handle 280 to the frame 220. Including a rotatable operator handle is particularly advantageous for applying the barrier material at an intersection of a wall and floor or ceiling. In such exemplary embodiments, wheels 286a and 286b may be provided on the beam 225 to which the handle 280 is rotatably coupled. A handle retaining feature, such as a clip 284 may be provided on the frame 220, for example, on another beam 223. The handle 280 may thus be rotated about the first beam 225 towards another beam 223 and removably attached thereto by the handle retaining feature (e.g., clip 284). Such an arrangement may be convenient for storage.

In other exemplary embodiments, the operator handle 280 may be rotationally attached to the beam 223, for example, as described above with respect to the beam 225. For example, the operator handle 280 may be attached to a tube or sleeve that is capable of rotating with respect to the beam 223. In an exemplary embodiment, two or more sleeves 288a and 288b may be disposed on the beam 223, and the handle 280 is attached to the sleeves 288a, 288b by means of an armature 282, as described above. In such exemplary embodiments, wheels 286a and 286b may be provided on the beam 223. A handle retaining feature, such as a clip 284 may then be provided on the first beam 225. The handle 280 may thus be rotated about the second beam 223 towards the first beam 225 and removably attached thereto by the handle retaining feature (e.g., clip 284).

During use, barrier material disposed on the barrier material roll 240 can be pulled across the first applicator roller 250 and further over the second applicator roller 260. A sheet of the barrier material disposed in contact with the first and second applicator rollers of typical embodiments forms a substantially planar configuration, such that when the barrier material applicator is moved along the floor 270, the sheet of barrier material may be conveniently applied to the floor 270 without excessive wrinkling As the applicator 200 is pushed or pulled by the operator, the barrier material can be transferred from the barrier material roll 240 to the first applicator roller 250 and further to the second applicator roller 260. Thus, the applicator rollers according to the present disclosure are capable of presenting barrier material to a horizontal surface in a substantially planar form, so that fewer wrinkles are formed, as well as rolling out barrier material wrinkles if such wrinkles do form.

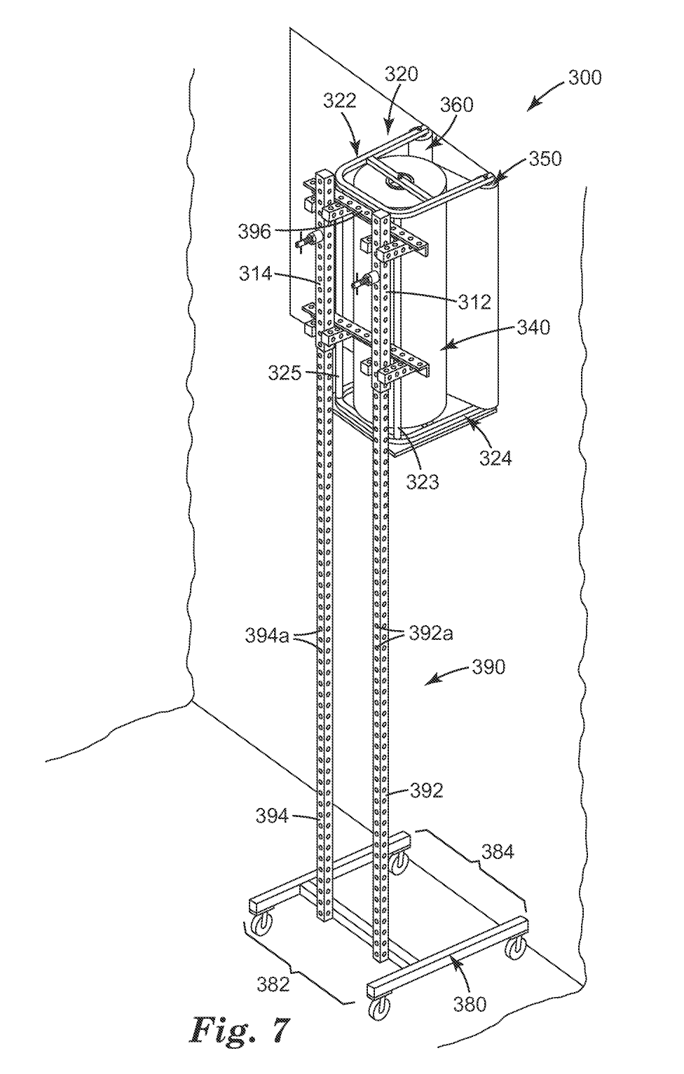

FIG. 7 shows yet another exemplary barrier material applicator 300, designed to apply a barrier material to a vertical wall surface. The barrier material applicator has a frame 320. A roll support member (not shown) is coupled to the frame 320 and is configured to rotatably support a roll of barrier material 340. The exemplary frame 320 includes an upper frame portion 322 and a lower frame portion 324. The upper and lower frame portions 322, 324 are connected, for example, by one or more beams 323, 325. The applicator 300 also includes a first applicator roller 350 configured to rotate about a first axis in at least a first direction; and a second applicator roller 360 configured to rotate about a second axis in at least a second direction. The first and second applicator rollers 350 and 360 are capable of rotating about their long axes in at least one direction and, more typically, in both directions (i.e., clockwise and counterclockwise). Preferably, the first applicator roller 350 is capable of rotating in the same direction as the second applicator roller 360. One or both the applicator rollers 350 and 360 may have any suitable construction and include any suitable materials, such as those described in connection with any of the previously described embodiments. For example, one or both of the applicator rollers may include conformable material disposed on an outer surface or an applicator roller.

The first and second applicator rollers 350 and 360 may be coupled to the frame 320 in a manner similar to that described in connection with other embodiments of the present disclosure. The barrier material applicator 300 may further include a base 380 which is movable with respect to a generally horizontal surface, e.g., a floor. Wheels may be coupled to the base 380 to effectuate its movability, as described in connection with the previously described embodiments. The base 380 may be shaped to have a cutout 382 on a side of the base that is farthest from the side of the first and second applicator rollers so that an operator may move closer to the base 380. Additionally or alternatively, a cutout 384 may be disposed on a side of the base that is on the side of the first and second applicator rollers. Thus, in some embodiments, the base 380 may be generally H-shaped.

The frame 320 may be coupled to the base 380 via a vertical support 390, for example, by one or more cross members 396. The vertical support 390 is coupled to the base 380 and extends away from the base in an upwards direction. The vertical support may include at least one shaft 392 with a non-circular cross-section. A shaft having a non-circular cross-section is advantageous in that it does not allow for the frame to rotate with respect to the support 390. In typical embodiments, at least one shaft 392 includes at least one corner or a similar anti-rotation feature. Preferably, a shaft cross-section is generally rectangular, where the term “rectangular” is meant to encompass a square shape. However, triangular and other non-circular shapes, such as an elliptical shape, are also within the scope of the present disclosure. Such exemplary shaft cross-sections reduce misalignment and make installation easier. In some exemplary embodiments, the support member 390 includes at least two shafts 392 and 394, one or both of which may have a non-circular cross-section, such as those mentioned above.

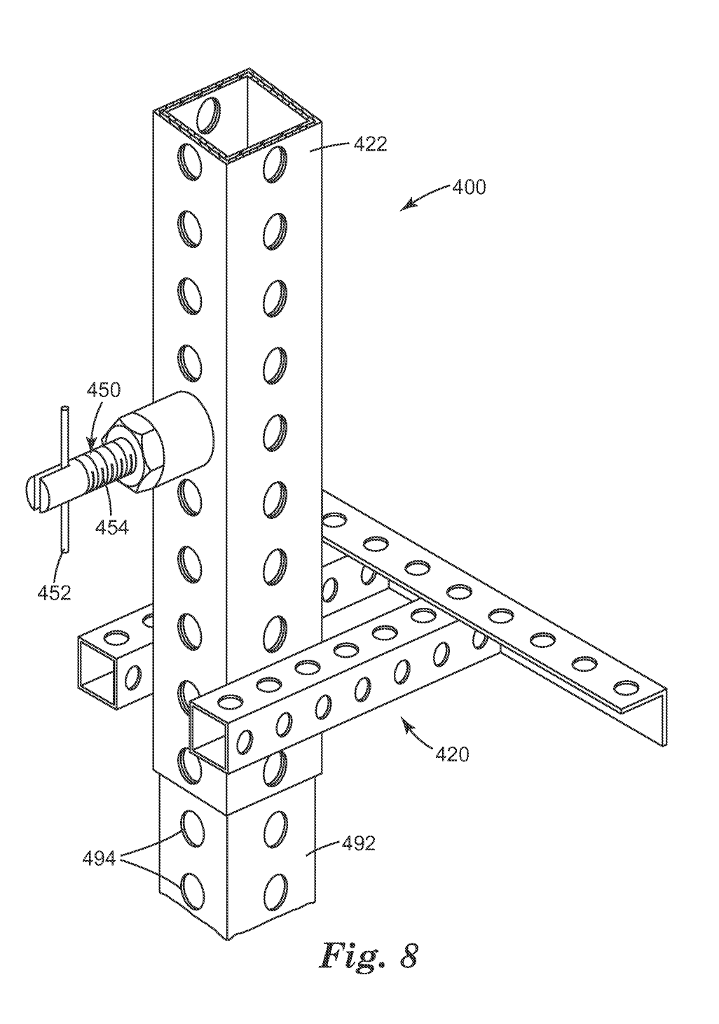

The vertical support member 390 and the frame 320 may be configured such that the frame is movable and repositionable with respect to the vertical support member so as to apply barrier material at different levels on vertical surfaces. Preferably, the vertical support member 390 is high enough to support to apply at least two sections of barrier material horizontally onto a wall surface. Accordingly, the vertical support member 390 may include a plurality of retaining features, while the frame includes a locking mechanism that is capable of selectively engaging one or more retaining features of the support member to retain the frame at a preselected height. In some exemplary embodiments, one or more of the retaining features can be one or more openings, as further described below in connection with FIGS. 7 and 8, but other configurations of retaining features are also within the scope of the present disclosure, including but not limited to one or more notches, ledges, other depressions or projections, or a combination thereof.

In one embodiment, shafts 392 and 394 include a plurality of openings 392a and 394a, respectively. Preferably, the openings are evenly spaced apart. The frame 320 includes sleeves 312 and 314, each configured to receive one of the shafts 392 and 394, respectively, therein. The remainder of the frame 320 may be permanently or removably attached to the one or more sleeves 312, 314. One or more sleeves 312, 314 may partially or completely surround one or more shafts 392, 394. A cross-section of the one or more sleeves may form the same geometrical figure, such as a rectangle, as the cross-section of one of more shafts. Or, a cross-section of the one or more sleeves may form a different geometrical figure than the cross-section of one of more shafts.

As further illustrated in FIG. 8, an exemplary shaft 492 has two or more evenly spaced openings 494 arranged along the length of the shaft 492. A locking mechanism, such as a spring pin mechanism, may be provided on a sleeve 422 of the frame 420 and used to engage the openings 494 on one or more of the shafts 492 of the vertical support member. An exemplary spring pin mechanism 450 may include a handle 452, a pin body 454, a spring pin (not shown), and a spring (not shown) that resiliently biases the spring pin through the sleeve 422 and into a selected opening 494 of the shaft 492. The handle 452 may be used to pull the pin out of an opening to adjust the height of the containment material applicator 400. Thus, with the aid of a locking mechanism according to the present disclosure, such as a spring pin 450, the frame 420 may be fixed and retained at the desired height. Other suitable locking mechanisms known to those of ordinary skill in the art are also within the scope of the present disclosure.

It will be apparent to those skilled in the art that the specific exemplary structures, features, details, configurations, etc., that are disclosed herein can be substituted, modified and/or combined in numerous embodiments. All such variations and combinations are contemplated by the inventors as being within the bounds of the conceived invention. Thus, the scope of the present invention should not be limited to the specific illustrative structures described herein, but rather by the structures described by the language of the claims, and the equivalents of those structures.

What is claimed is:

1. A barrier material applicator comprising:
a frame;
a roll support member coupled to the frame, the roll support configured to rotatably support a roll of barrier material;
a first applicator roller configured to rotate about a first axis in at least a first direction; and
a second applicator roller configured to rotate about a second axis in at least a second direction, the second direction being the same as the first direction;
wherein the first applicator roller and the second applicator roller are configured to receive a sheet of barrier material from the roll support and apply it to a substantially planar surface.

2. A barrier material applicator as recited in claim 1, wherein the first axis and the second axis define a plane.

3. A barrier material applicator as recited in claim 1, wherein the first axis is parallel to the second axis.

4. A barrier material applicator as recited in claim 1, wherein the roll of barrier material is rotatable about a third axis and the third axis is parallel to the first axis and the second axis.

5. A barrier material applicator as recited in claim 1, wherein the first and second applicator rollers each comprise a conformable material.

6. A barrier material applicator as recited in claim 1, further comprising a base movable with respect to a generally horizontal surface, and wherein the frame is coupled to the base.

7. A barrier material applicator as recited in claim 6, wherein the base comprises a cutout on a side of the base that is farthest from the side of the first and second applicator rollers.

8. A barrier material applicator comprising:
a frame;
an elongated operator handle coupled to the frame;
a roll support member coupled to the frame, the roll support configured to rotatably support a roll of barrier material;
a first applicator roller configured to rotate about a first axis in at least a first direction; and
a second applicator roller configured to rotate about a second axis in at least a second direction, the second direction being the same as the first direction;
wherein the first applicator roller and the second applicator roller are configured to receive a sheet of barrier material from the roll support and apply it to a substantially planar surface.

9. A barrier material applicator as recited in claim 8, wherein the operator handle is rotatably coupled to the frame.

10. A barrier material applicator as recited in claim 9, wherein the frame comprises a beam and the operator handle is rotatably coupled to the beam and wherein the frame further comprises at least two wheels coupled to the frame at opposing sides of the beam.

11. A barrier material applicator as recited in claim 9, wherein the frame further comprises a handle retaining feature for removably retaining the operator handle to the frame.

12. A barrier material applicator as recited in claim 8, wherein the first axis is parallel to the second axis.

13. A barrier material applicator comprising:
a base movable with respect to a generally horizontal surface;
a vertical support coupled to the base and extending away from the base;
a frame coupled to the vertical support;
a roll support member coupled to the frame, the roll support configured to rotatably support a roll of barrier material;
a first applicator roller configured to rotate about a first axis in at least a first direction; and
a second applicator roller configured to rotate about a second axis in at least a second direction, the second direction being the same as the first direction;
wherein the first applicator roller and the second applicator roller are configured to receive a sheet of barrier material from the roll support and apply it to a substantially planar surface.

14. A barrier material applicator as recited in claim 13, wherein the vertical support comprises a shaft having a non-circular cross-section.

15. A barrier material applicator as recited in claim 13, wherein the vertical support comprises at least two shafts.

16. A barrier material applicator as recited in claim 13, wherein the frame is repositionable with respect to the vertical support.

17. A barrier material applicator as recited in claim 13, wherein the frame comprises at least one locking mechanism for releasably retaining the frame to the vertical support at a predetermined height.

18. A barrier material applicator as recited in claim 17, wherein the vertical support comprises a plurality of openings and the locking mechanism comprises a spring pin mechanism configured to engage at least one of the plurality of holes to retain the frame at a predetermined height.

19. A barrier material applicator as recited in claim 13, wherein the first axis and the second axis define a plane.

20. A barrier material applicator as recited in claim 13, wherein the first axis is parallel to the second axis.
